(19) United States
(12) Patent Application Publication
(10) Pub. No.: US 2006/0174248 A1
(43) Pub. Date: Aug. 3, 2006

(54) Software tool for automatically protecting shared resources within software source code

(76) Inventors: Robert Marc Zeidman, Cupertino, CA (US); Michael Barr, Elkridge, MD (US)

Correspondence Address: Zeidman Technologies, Inc.;Suite 210, 4950 Hamilton Ave, San Jose, CA, 95130, US

(21) Appl. No.: 11/052,426

(22) Filed: Feb. 3, 2005

(51) Int. Cl. G06F 9/46

(52) U.S. Cl. 718/104

(57) ABSTRACT

A method for identifying shared resources in multiple tasks in a multitasking system and for automatically inserting code to protect these shared resources from race conditions due to access by more than one task.

### BACKGROUND OF THE INVENTION

1. Field of the Invention

The present invention relates to tools for software development.

2. Discussion of the Related Art

In a multitasking software system, multiple tasks (and interrupt service routines) can execute simultaneously or appear to execute simultaneously. In a system with multiple processors, single tasks can execute simultaneously on each processor. In systems with processors that contain multiple execution units and redundant register sets, multiple tasks can execute simultaneously on the single processor. On traditional processors, an operating system can arbitrarily allocate short amounts of time to each processor to execute specific tasks. Though only one task executes at any given time, the tasks appear to execute simultaneously, and execution can begin and pause at any arbitrary software instruction in the task source code. Interrupt service routines can be treated as additional tasks for the purpose of the analysis that follows.

There are certain hazards, called race conditions, that occur in these multitasking systems and that can produce incorrect results. Race conditions occur when one task accesses a shared variable or a shared resource while at or around the same time another task accesses the same shared variable or resource. FIG. 1 shows an example of two such tasks. This figure shows software source code 100 for two tasks in a multitasking system, both of which access the shared global variable task_count. Line 101 declares task_count as an integer and initializes it to the value 0. The task_count variable holds the number of times either task1 or task2 have executed. Line 102 is the declaration of the task1 task. Line 103 declares an integer variable called count that is local to task1. In line 104, the value of global variable task_count is stored in local variable count. The task then executes the rest of its function. At line 105, local variable count is incremented and at line 106, local variable count is stored back into global variable task_count before task1 terminates. The curly bracket at line 107 signifies the end of task1.

Line 108 is the declaration of the task2 task. Line 109 executes after task2 has performed its function at which time the global variable task_count is incremented. The curly bracket at line 110 signifies the end of task2.

Since it is not possible to know when task1 and task2 instructions will execute with respect to each other, it is possible for line 103 of task1 to execute before task2 has begun and lines 105 and 106 of task1 to execute after task2 has completed. In this case, suppose task_count already has some value x representing the number of times the tasks have executed. When line 101 is executed, local variable count gets the value x. Then task task2 executes and at line 109, task_count is incremented to x+1. After task2 completes, line 105 increments count to x+1 and line 106 stores count into task_count. At this point, the variable task_count has the value x+1 rather than the correct value x+2.

One can argue that task1 should not be written using a local variable to store the value of a global variable or that the operation of incrementing the global variable should not be performed by instructions spread throughout the task. Nevertheless, this action is allowed and can be written in this way knowingly or inadvertently. Also, even when a single increment is coded, such as line 109, this high level increment instruction typically is compiled into several low-level assembly instructions that store the variable in a register, increment the register, and store the new value back to the global variable. This sequence can be also be interrupted by another task and thus does not protect against race conditions.

FIG. 2 shows an example of two tasks accessing a shared resource. This figure shows software source code 200 for two tasks in a multitasking system, both of which access the printer port. Line 201 is the declaration of the task1 task that takes arguments portnum, buffer, and buflen. The portnum argument is the number of the printer port to be accessed. The buffer argument contains a pointer to a buffer of characters to be printed. The buflen argument is the number of characters in the buffer to be printed. Line 202 is a loop that increments the index i into buffer. Line 203 outputs a character to the printer port. The curly bracket at line 204 signifies the end of task1. Line 205 declares the task2 task that takes arguments port and message. The port argument is the number of the printer port to be accessed. The message argument contains a string of character. Line 206 is a loop that increments the index i into message. Line 207 outputs a character of the message to the printer port. The curly bracket at line 208 signifies the end of task2.

In a multitasking system it is possible for task 1 and task 2 to be executing simultaneously. In this case, characters from buffer in task1 and message in task2 will be interspersed in the output to the printer port, resulting in a printout that is unreadable.

FIG. 3 shows an example of two tasks accessing a shared resource. This figure shows software source code 300 for two tasks in a multitasking system, both of which execute the same reentrant function. Task task1 is declared at line 301. At line 302 a thread is created that holds a pointer to a function to be run by the operating system. At line 303, the thread pointer is given the value of the valPrint function, informing the operating system to run the valprint function as a task in its own thread. Line 304 signals the end of task1. Task task2 is declared at line 305. At line 306 a thread is created that holds a pointer to a function to be run by the operating system. At line 307, this thread pointer is given the value of the valprint function, informing the operating system to run function valprint as a task in its own thread. Line 308 signals the end of task2. In this multitasking system, valPrint is executed by two individual tasks simultaneously (i.e., a reentrant function) without protection, and thus one task running valPrint could interfere with the execution of the other valprint task.

In order to protect against multiple tasks accessing shared resources simultaneously, the prior art makes use of mutexes or interrupt disabling. Mutexes are data structures that are defined by operating systems and used by tasks to ensure exclusive access to shared resources. Similar data structures called binary semaphores and counting semaphores can generally be used in place of mutexes, with appropriate initialization. A mutex for a shared resource is set in one task to signal that the particular resource is in use and that another task should not use it. The mutex is reset when the task is done with the shared resource, allowing other tasks to use it. Any task wishing to use a shared resource must first check the mutex for the resource and wait for the mutex to be reset. FIG. 4 shows prior art software source code 400 for two tasks in a multitasking system. Each task uses a mutex to protect access to a global variable. Line 401 declares the mutex that controls access to the shared variable task_count. Line 402 in task1 is an operating system specific applications program interface (API) that waits for the mutex for task_count to be reset at which time it sets the mutex and allows task1 to continue executing. Line 403 resets the mutex signaling to other tasks that are waiting for the global variable task_count that the variable can be accessed. Similarly in task2, line 404 waits for the mutex for task_count to be reset at which time it sets the mutex and allows taski to continue executing. Line 405 resets the mutex signaling to other tasks that are waiting for the global variable task_count that the variable can be accessed. Similar code can be written using mutexes to protect other shared resources like a printer port or a shared task.

The problem with using mutexes (or semaphores) is that programmers must be aware of all shared resources and must correctly insert code to set, reset, and check the mutexes. Much debugging time is spent in a multitasking system because a programmer has not correctly understood or correctly written the code for controlling the mutexes, resulting in errors that can only be discovered when the code has been compiled and run under the appropriate conditions. These appropriate conditions include a program state and a set of inputs that causes several tasks to access the shared resource simultaneously, which may not occur often, if at all, during testing of the system.

### SUMMARY OF THE INVENTION

The present invention provides a system and a method that examine computer program source code for a multitasking system and automatically protects shared resources such as shared variables and shared hardware from being accessed by one task while in the process of being accessed by another task. The present invention provides a method of automatically protecting shared resources without requiring the programmer to understand or implement the protection mechanism. The present invention improves the reliability of a multitasking software system and decreases the time spent debugging such a system.

The present invention provides a software tool that examines all the source code for a multitasking system and creates a list of all global resources in that system. The tool then examines the source code for each task in the system and identifies all shared global resources that are accessed by more than one task. The tool then places protection code around sets of instructions that access each such shared global resource, protection code being code that allows access to the shared resource without interruption by other tasks.

Further features and advantages of various embodiments of the present invention are described in the detailed description below, which is given by way of example only.

### BRIEF DESCRIPTION OF THE DRAWINGS

The present invention will be understood more fully from the detailed description given below and from the accompanying drawings of the preferred embodiment of the invention, which, however, should not be taken to limit the invention to the specific embodiment but are for explanation and understanding only.

FIG. 1 shows software source code for two tasks in a multitasking system, each of which accesses a global variable.

FIG. 2 shows software source code for two tasks in a multitasking system, each of which accesses a printer port.

FIG. 3 shows software source code for two tasks in a multitasking system, each of which starts execution of a reentrant function in a new thread.

FIG. 4 shows prior art software source code for two tasks in a multitasking system, each of which uses a mutex to protect access to a global variable.

FIG. 5 shows the flow of source code through a multi-pass tool.

FIG. 6 shows C code for global variables and for two tasks in a multitasking system. It also shows a list of global variables extracted from the C code.

FIG. 7 is a flowchart for the first pass of a three-pass implementation of the present invention.

FIG. 8 shows C code for global variables and for two tasks that access global variables in a multitasking system. It also shows a list of global variables extracted from the C code, corresponding lists of the number of tasks in which each global variable is accessed, and lists of the line number within specific tasks for the first and last access of the global variable.

FIG. 9 is a flowchart for the second pass of a three-pass implementation of the present invention.

FIG. 10 shows C code for global variables and for two tasks that access global variables in a multitasking system, where protection routines have been placed around shared global variable accesses.

FIG. 11 is a flowchart for the third pass of a three-pass implementation of the present invention.

FIG. 12 shows C code for global variables and for two tasks that access global variables in a multitasking system, where optimized protection routines have been efficiently placed around shared global variable accesses.

FIG. 13 shows C code for global variables and for two tasks that access global variables in a multitasking system, where optimized protection routines have been efficiently placed around shared global variable accesses.

FIG. 14 shows C code for a shared hardware resource and for two tasks that access the shared hardware resource in a multitasking system, where optimized protection routines have been efficiently placed around shared global variable accesses.

FIG. 15 shows C code for a shared task and for two tasks that execute the shared task in separate threads in a multitasking system, where optimized protection routines have been efficiently placed around calls to execute the shared task.

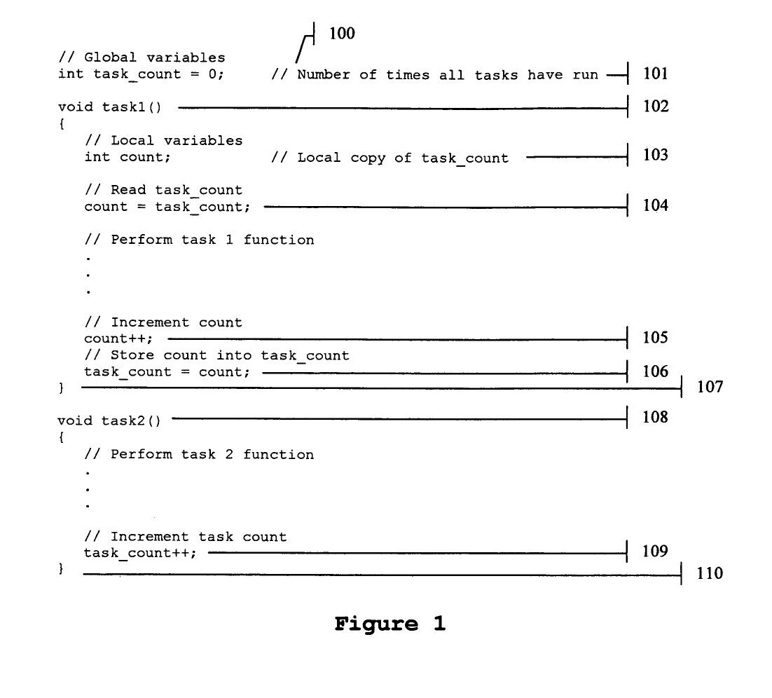

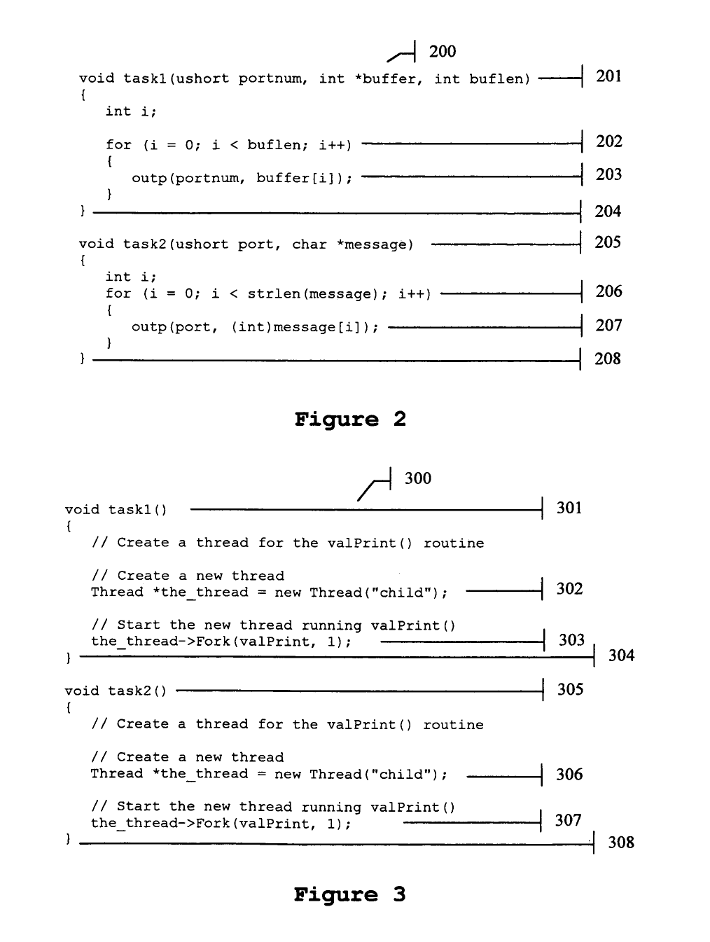

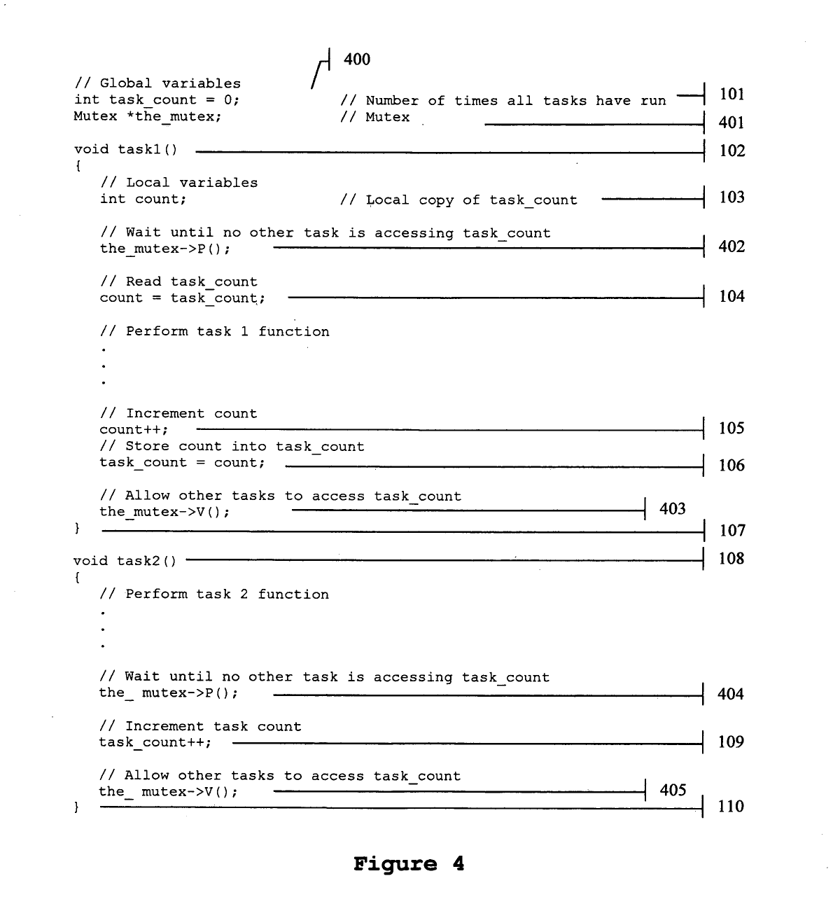

### DETAILED DESCRIPTION

The present invention will be understood more fully from the detailed description given below and from the accompanying drawings of the preferred embodiments of the invention, which, however, should not be taken to limit the invention to the specific embodiments but are provided for explanation and understanding only.

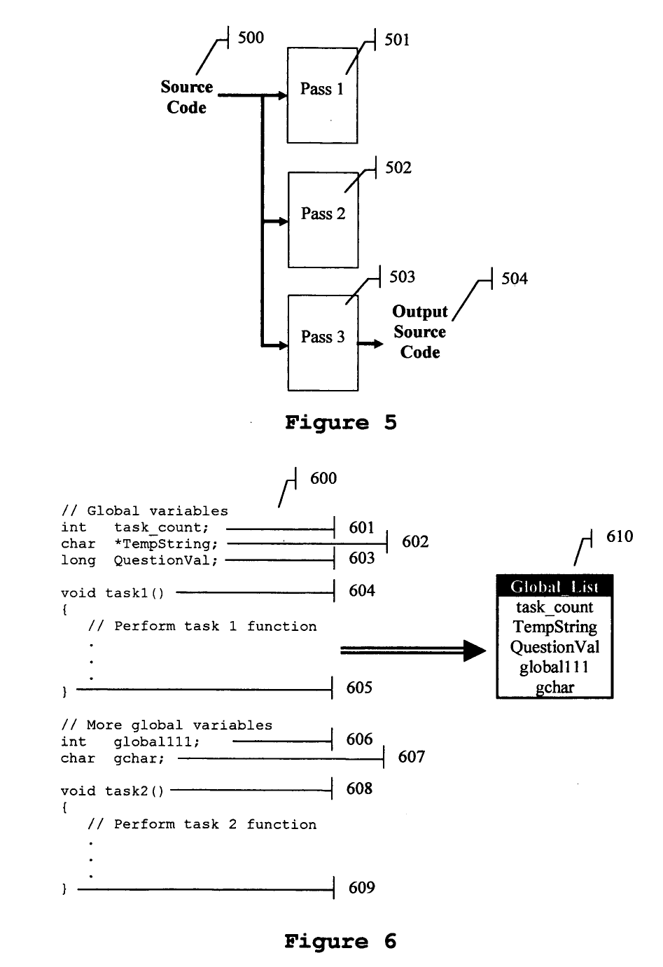

The present invention provides a software tool that examines all the source code for a multitasking system and that creates a list of all shared resources in that system. In one embodiment, the tool performs multiple passes examining the source code for the system in the manner shown in FIG. 5. The system source code 500 is input data to the tool. In the first pass 501 the tool examines each line of code and gathers information about the source code. In second pass 502, the tool examines each line of source code and gathers further information about the code. In the third pass 503, the tool modifies the source code 500 to create the output source code 504.

In one embodiment of the tool, the tool considers each function to be a task in the multitasking system and places protection statements around each function call. This assumption results in correct operation but may not be efficient. In another embodiment, the tool is aware of all the tasks that are running on top of the operating system. The tool can determine these tasks in several ways. In one embodiment the tool is aware of operating system calls that are used to begin execution of tasks. The tool can search the system source code for all these OS calls to determine which routines are tasks in order to place protection statements around each task call. In another embodiment, the OS has a table that lists all the tasks in the system, and the tool examines these tasks. In another embodiment, the user places special directives, comments, or other kinds of programming statements in the code for each task, which the tool finds when examining the system source code. In another embodiment, the user creates a configuration table that lists all the tasks in the system. The tool can determine these tasks, to protect them, in other ways that are known to one of ordinary skill in the art.

FIG. 6 shows sample C code for global variables and for two tasks in a multitasking system and a list of global variables extracted from the C code 600. During first pass 501, the tool recognizes standard C variable declarations 601, 602, and 603 that are not contained inside a routine and thus declare global variables. The tool creates a list of these variables: task_count, TempString, and QuestionVal, which are represented by Global_List 610. When the tool reads line 604, it recognizes the code for the declaration of a routine task1. Variable declared within routine task1 are not global variables so the tool continues reading source code lines until it reaches curly bracket 605, which signifies the end of the task1 routine. The tool then reads variable declarations 606 and 607, which are declared outside a routine and are thus global variables. The tool adds global variables global111 and gchar to Global_List 610. When the tool reads line 608, it recognizes the code for the declaration of a routine task2 and continues reading source code lines until it reaches curly bracket 609, which signifies the end of the task1 routine. The tool then reaches the end of the file. The tool repeats the process by reading each source code file in the system and adding all global variables to Global_List.

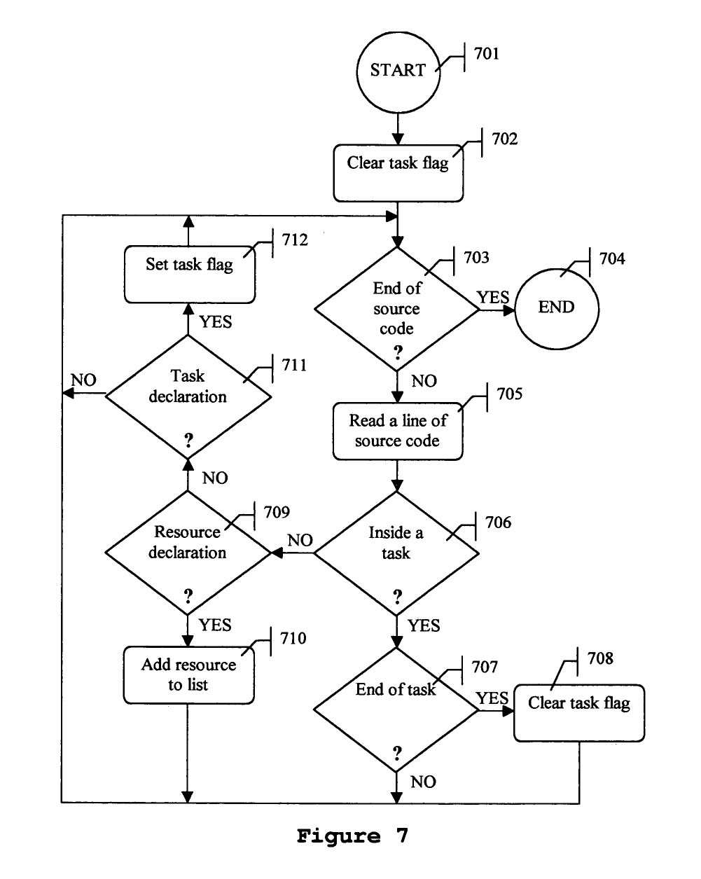

FIG. 7 is a flowchart for the tool for executing this first pass 501. The tool starts out in block 701, then progresses to block 702 where it clears the task flag, which is an internal bit used to determine whether the tool is currently examining a task. The tool then progresses to block 703. If the end of the source code has been reached, the tool progresses to block 704, ending the first pass 501. If there is more source code to read, the tool progresses to block 705 where it reads a line of the system source code. The tool progresses to block 706 and checks the task flag to determine whether the tool is currently examining a task. If the tool is examining a task, it progresses to block 707, where it determines whether the source code line is an end-of-task statement. If the line is an end-of-task statement, the tool progresses to block 708, where it clears the task flag and goes back to block 703. If the line is not an end-of-task statement, the tool progresses from block 707 back to block 703.

At block 706, if the tool is not inside a task, it progresses to block 709, where it checks whether the statement is a resource declaration such as the declaration of a global variable. If the statement is a resource declaration, the tool progresses to block 710 where it adds the resource to the resource list, Global_List 610, and goes back to block 703. At block 709 if the statement is not a resource declaration! the tool progresses to block 711, where it determines whether the source code line is a task declaration. If the line is not a task declaration, the tool goes back to block 703. Otherwise the tool progresses to block 712 where it sets the task flag and then goes back to block 703. In cases where tasks consist of nested routines and functions, keeping track of the beginning and the end of tasks requires additional steps that are not specifically included in this flowchart, but in general terms the flowchart is the same.

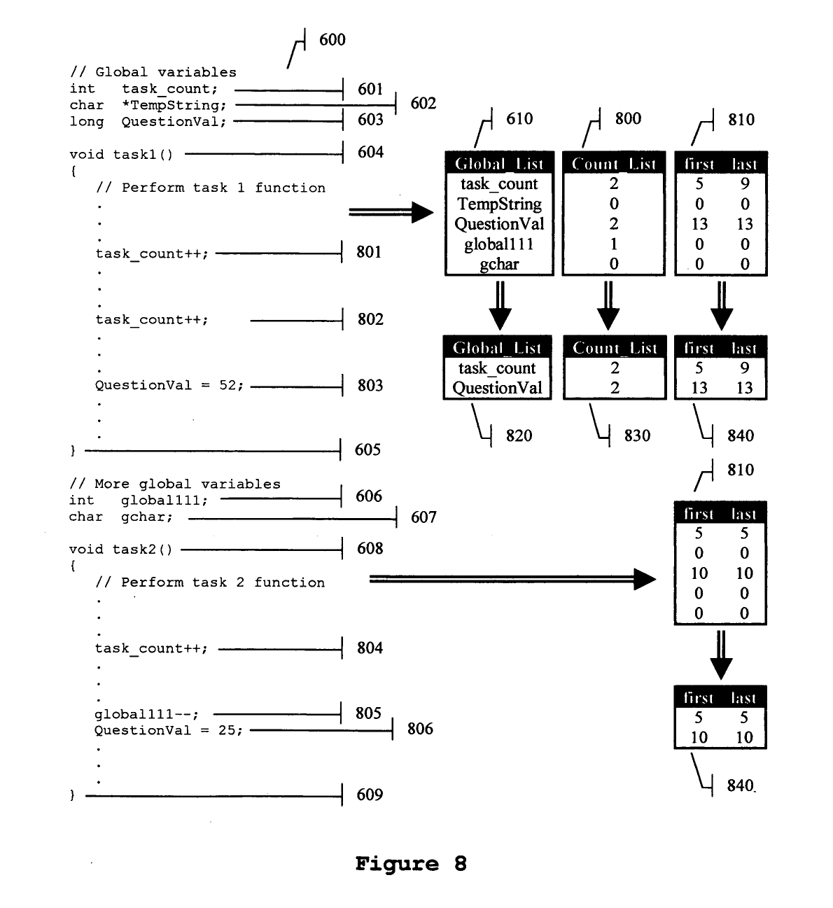

Once all the source code has been examined by the tool and the list of global variables 610 is complete, the tool creates a new list of numbers, with each number representing the number of tasks that access a corresponding global variable, as shown by list Count_List 800 in FIG. 8. In a second pass 502 the tool examines the source code a second time. FIG. 8 shows more of the C source code for the two tasks task1 and task2 that were shown in less detail in FIG. 6. In this pass, the tool examines each line of source code within each task. For each task within the system, two lists 810 are created. Each list consists of two values, labeled “first” and “last”. The lists 810 are initialized to all zeroes. Each value in the “first” column represents the line number of the first access in the task of the corresponding shared resource in Global_List 610. Each value in the “last” column represents the line number of the last access in the task of the corresponding shared resource in Global_List 610. Whenever the first line of code within a task is found that accesses a global variable, such as lines 801, 802, 803, 804, 805, and 806, the tool increments the location in list Count_List 800 that corresponds to the same location as the global variable in list Global_List 610. If a line of code is found that accesses the same global variable that was accessed in a previously found line of code in the same task, such as line 802, the corresponding location in the list Count_List 800 is not incremented. After all the code has been examined a second time, the list Global_List 610 contains all the global variables in the source code for the system, the list Count_List 800 contains the number of tasks that access the corresponding global variable in list Global_List 610, and each task has two lists 810 that contain the numbers of the first line and last line that access the corresponding global variable in list Global_List 610.

Next the tool examines the list Count_List 800. For each entry in the list Count_List 800 that has a value of 0 or 1, the list entry is eliminated and the corresponding entry in the list Global_List 610 is eliminated. Also, for each entry in the list Count_List 800 that has a value of 0 or 1, the corresponding entries in the “first” and “last” lists 810 for each task in the system are eliminated. An example result is shown in modified lists Global_List 820, Count_List 830, and first/last lists 840 that were generated from original lists Global_List 610, Count_List 800, and first/last lists 810.

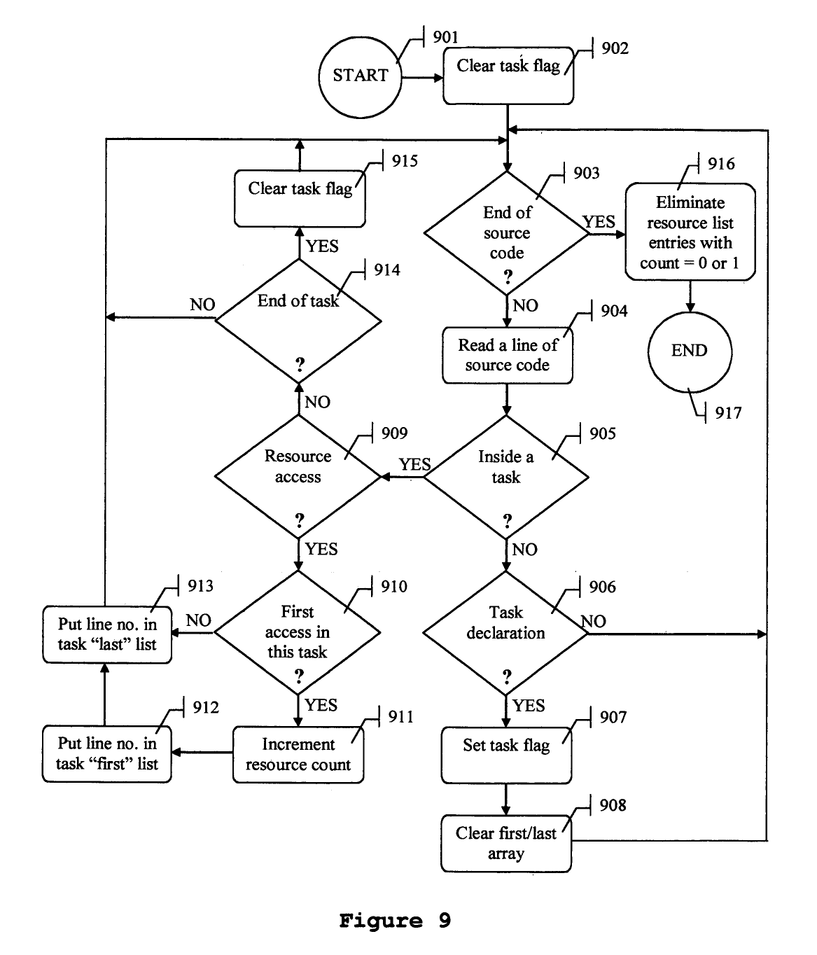

FIG. 9 is a flowchart for the tool for executing this second pass. The tool starts out in block 901, then progresses to block 902, where it clears the task flag, which is an internal bit used to determine whether the tool is currently examining a task. The tool then progresses to block 903. If the end of the source code has not been reached, the tool progresses to block 904, where it reads a line of system source code and then progresses to block 905, where it checks the task flag to see if it is currently reading code inside a task. If the tool is not reading code inside a task, it progresses to block 906, where the tool determines whether the source code line is a task declaration. If the line is not a task declaration, the tool goes back to block 903. Otherwise the tool progresses to block 907, where the task flag is set. The tool progresses to block 908, where it creates a first/last array for the current task and resets all entries to zero. The tool then goes back to block 903.

In block 905, if the task flag is set, which signifies that the tool is reading source code from inside a task, the tool progresses to block 909, where it checks whether the source code line is accessing a resource in the global resource list, Global_List 610, which was created in the first pass. If the source code line is not accessing a resource in the global resource list, the tool progresses to block 914, where it checks whether the current source code line is an end-of-task statement. If the line is not an end-of-task statement, the tool goes back to block 903. Otherwise the tool progresses to block 915, where it clears the task flag and then goes back to block 903.

In block 909, if the source code line is accessing a resource in the global resource list, Global_List 610, the tool progresses to block 910, where it checks whether the specific global resource being accessed has been accessed by a previous line of source code in the current task and was thus already noted by the tool. This checking is done simply be checking whether the entry for the particular global resource in the “first” list of the first/last lists 810 is non-zero. If the specific global resource has already been accessed by a line of source code in the current task and was thus already noted by the tool, the tool progresses to block 913, where it places the current line number in the “last” list of the first/last list 810 that corresponds to the specific global resource. The tool then goes back to block 903.

When the tool is in block 910 and the specific global resource has not already been accessed by a line of source code in the current task, the tool progresses to block 911 where it increments the entry in Count_List 800 that contains the number of tasks that access the corresponding global variable in list Global_List 610. The tool then progresses to block 912 where it places the current line number in a position in the “first” list of the first/last list 810 that corresponds to the specific global resource. Then the tool progresses to block 913, where it places the current line number in the “last” list of the first/last list 810 that corresponds to the specific global resource. The tool then goes back to block 903.

In block 903, if the end of the source code has been reached, the tool progresses to block 916, where it goes through each entry in Global_List 610, Count_List 800, and the first/last lists 810 for each task, eliminating all entries in all lists where the count in Count_List 800 equals 1 or 0. The count signifies that only one task accesses the resource or no task accesses the resource, respectively. In these cases, protection is unnecessary. The new lists, after eliminating entries, are the modified lists Global_List 820, Count_List 830, and first/last lists 840. The tool then progresses to block 917, which is the end of this pass.

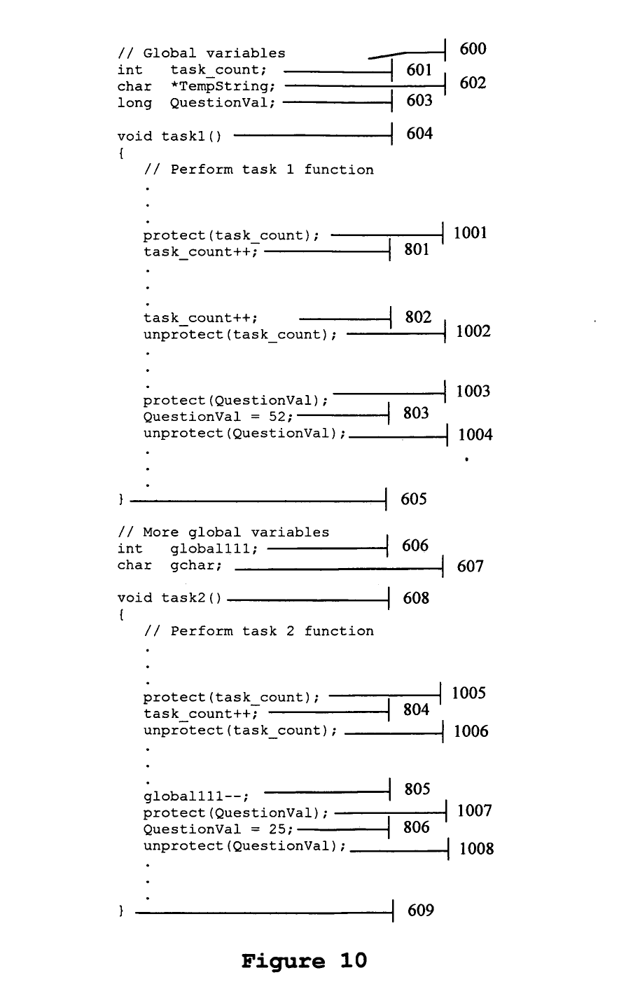

In a third pass 503, the tool examines the source code for the system a third time. The tool notes each line of code where a task accesses a shared global variable in the modified list Count_List 830. As shown in FIG. 10, the tool modifies the source code by placing initial protection statements 1001, 1003, 1005, and 1007 before the first access of a shared global variable in every task and ending protection statements 1002, 1004, 1006, and 1008 after the last access of a shared global variable in each task.

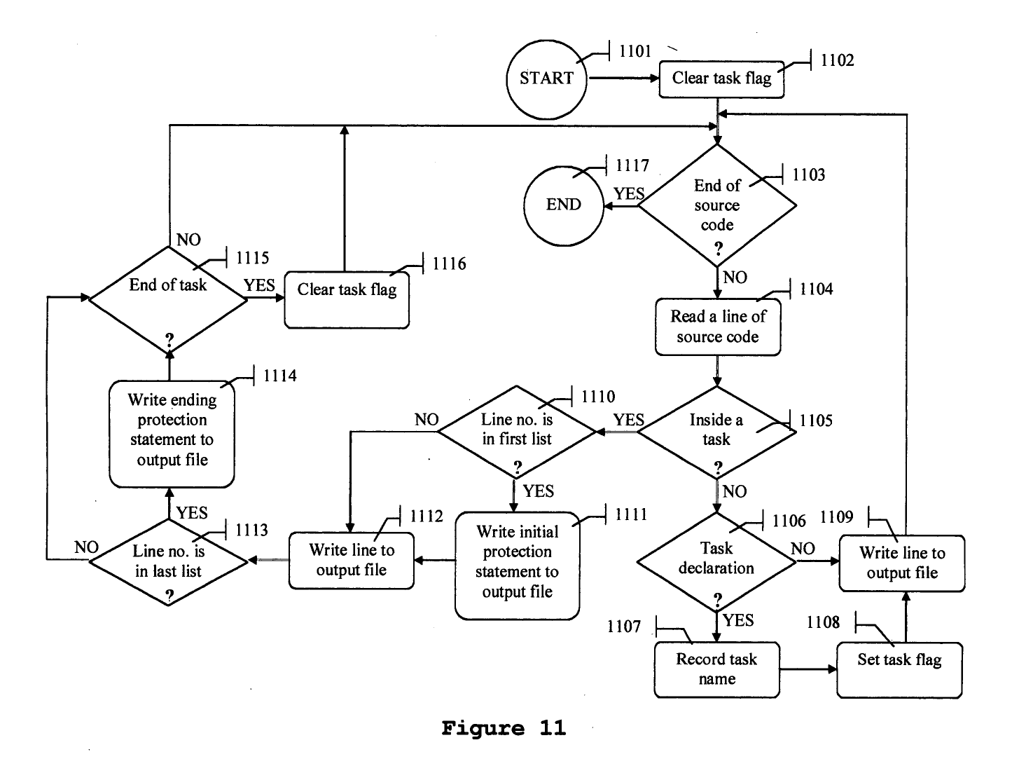

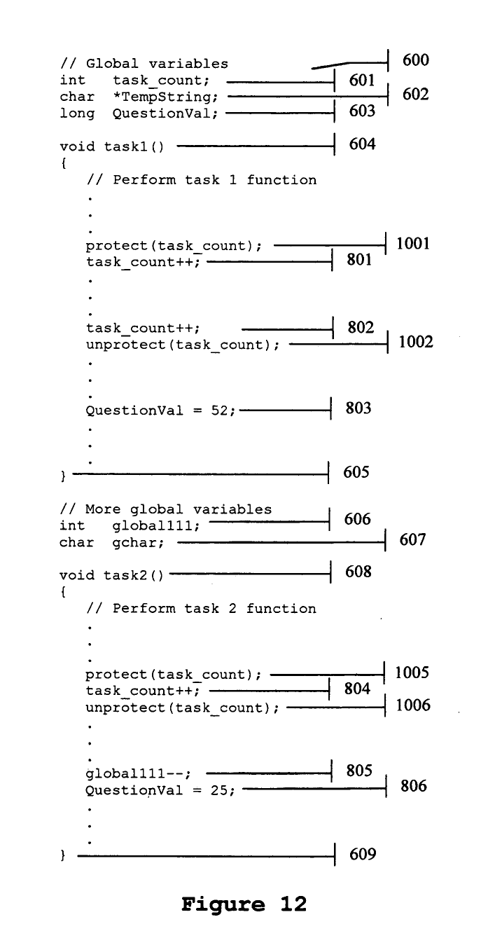

FIG. 11 is a flowchart for the tool for executing this third pass. The tool starts out in block 1101, then progresses to block 1102 where it clears the task flag, which is an internal bit used to determine whether the tool is currently examining a task. The tool then progresses to block 1103 where it tests whether it has reached the end of the system source code. If the end of the source code has been reached, the tool progresses to block 1117, where the tool completes execution. Otherwise the tool progresses to block 1104 and reads a line of system source code. The tool then progresses to block 1105, where it checks whether it is currently reading source code from inside a task. If it is not reading source code from outside a task, the tool progresses to block 1106, where it checks whether the line of source code is a task declaration. If the line is not a task declaration, the tool progresses to block 1109, where it writes the line of source code to the file that is the output of the tool and then goes back to block 1103.

In block 1106, if the line of source code is a task declaration, the tool progresses to block 1107 where the tool records the name of the task. The tool then progresses to block 1108 where it sets the task flag, which signifies that source code is being read from a task. The tool then progresses to block 1109, where it writes the line of source code to the file that is the output of the tool and then it goes back to block 1103.

When the tool is in block 1105 and the task flag is set, which signifies that source code is being read from a task, the tool progresses to block 1110 where it tests whether the current line number corresponds to the number in the “first” list associated with the current task. If the line number does correspond, the tool progresses to block 1111, where it writes an initial protection statement to the output file. Then the tool progresses to block 1112, where it writes the line of source code to the output file. In block 1110, if the current line number does not correspond to the number in the “first” list associated with the current task, the tool progresses directly to block 1112, where the tool writes the line of source code to the output file.

From block 1112 the tool progresses to block 1113, where it tests whether the current line number corresponds to the number in the “last” list associated with the current task. If the line number corresponds, the tool progresses to block 1114, where it writes an ending protection statement to the output file and then progresses to block 1115. In block 1113, if the current line number does not correspond to the number in the “last” list associated with the current task, the tool progresses directly to block 1115. In block 1115 the tool checks whether the current source code line is an end-of-task statement. If the line is an end-of-task statement, the tool progresses to block 1116 where it clears the task flag, which signifies that the tool is no longer reading source code in a task. The tool the goes back to block 1103. In block 1115 if the current source code line is not an end-of-task statement, the tool goes back to block 1103.

In another embodiment of the tool, the third pass is more efficient about placing protection code around accesses of shared global variables. FIG. 12 shows the results of such a more efficient placement, where the code in FIG. 12 is identical to the code in FIG. 10 except that initial protection statements 1003 and 1007 and ending protection statements 1004 and 1008 are not placed in the code by the tool. The tool recognizes that setting a shared global variable to a value requires only one operation. Only operations that correspond to multiple small operations by the processor can be interrupted and thus need protection.

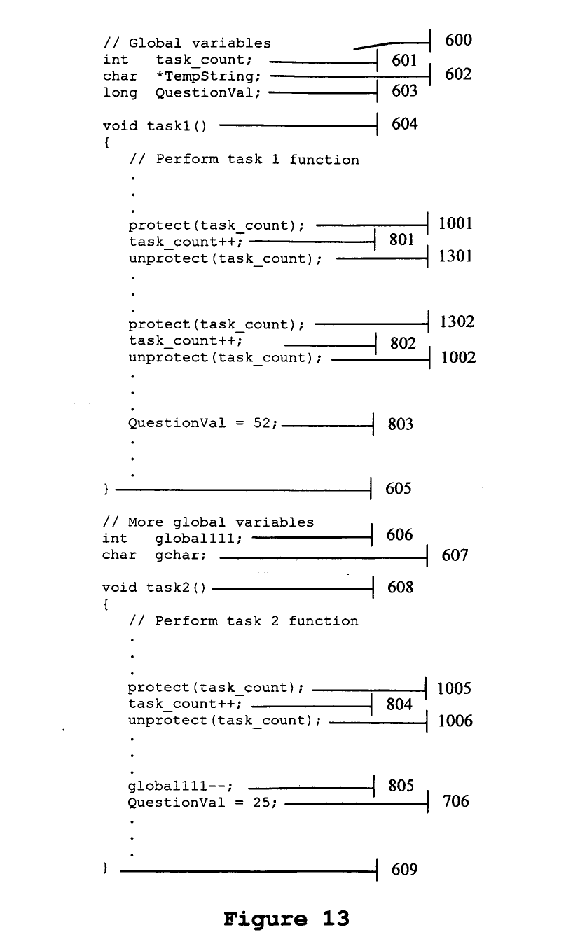

In yet another embodiment of the tool, the third pass is more efficient about placing protection code around accesses of shared global variables. FIG. 13 shows the results of such a more efficient placement, where the code in FIG. 13 is identical to the code in FIG. 12 except that ending protection statement 1301 and initial protection statement 1302 have been added so that two smaller sections of code that access global variable task_count are protected. Protecting smaller sections of code result in better overall system efficiency because it allows more time during which high priority tasks can interrupt lower priority tasks and get execution time from the operating system.

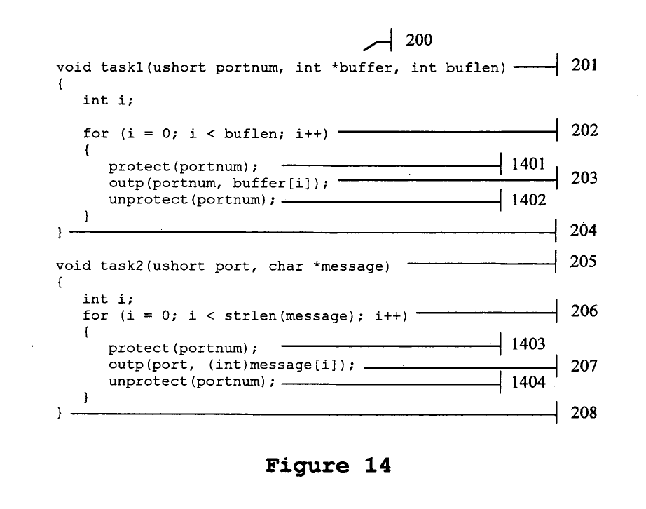

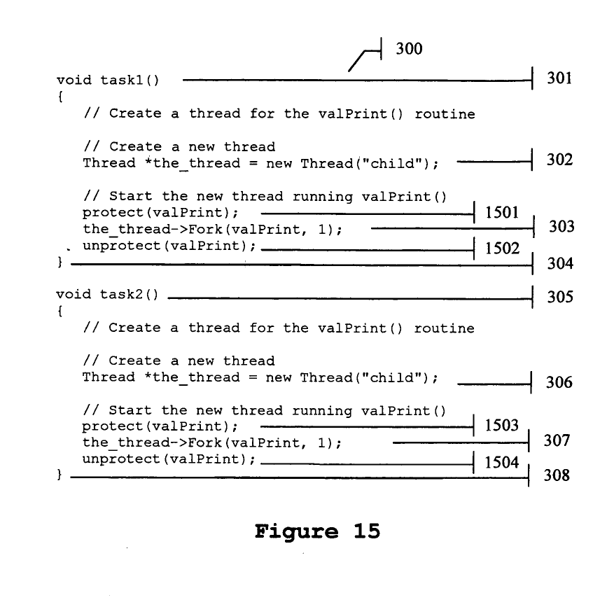

In FIG. 14, protection statements 1401, 1402, 1403, and 1404 have been placed around accesses of a shared hardware resource using the same method described above for placing protection statements around a shared global variable. In FIG. 15, protections statements 1501, 1502, 1503, and 1504 have been placed around statements that begin thread execution of a common task using the same method described above for placing protection statements around a shared global variable.

As described above, mutexes can be the protection mechanism used so that the shared resource can be used by one section of code at any given time. In cases where a shared resource is used by an interrupt service routine (ISR), interrupt masking can be used for protection. Interrupt masking is a way to turn off interrupts in software. If shared resource R is used by the ISR that services interrupt I, any accesses of resource R (outside the ISR for I) will begin with a statement that masks interrupt I and will end with a statement that enables interrupt I. In this way, if interrupt I occurs during the section of code that accesses R, the interrupt will not be serviced until the section of code has completed executing and the access of R has completed.

In yet another embodiment of the tool, a programming language parser is used as an initial pass of the tool to translate the user's source code into an abstract, intermediate form representing the semantics of the application independent of the syntax of the programming language. The three passes of the tool act on this abstract representation rather than the original source code. The abstract representation can be easily examined to identify shared resources. The abstract representation can give a clear representation of the program flow including alternate execution branches. The abstract representation can also be examined to efficiently identify all locations in the source code where these shared resources are initially accessed, and thus need to be protected, and all locations in the source code where these shared resources are released, and the protection can be turned off. By using a single intermediate form, a new programming language can be accommodated simply by writing a new parser for that language. Using a programming language parser allows the tool to support multiple languages without having to rewrite the transformations previously described for each language. Using a programming language parser also allows users the capability of writing their application in more than one programming language.

With respect to the present invention, the protection mechanism can be implemented in many different ways. Other software mechanisms for protection of shared variables, shared hardware resources, and critical sections within functions that may be called by two or more tasks simultaneously may be implemented in several ways that are well known to one of ordinary skill in the art.

Various modifications and adaptations of the operations that are described here would be apparent to those skilled in the art based on the above disclosure. Many variations and modifications within the scope of the invention are therefore possible. The present invention is set forth by the following claims.

I claim:

1) A method for protecting shared resources of a computer that are accessed by a plurality of computer programs running on said computer, comprising:
a) reading source codes of said computer programs and identifying said shared resources;
b) reading said source codes and identifying accesses to said shared resources;
c) inserting initial protection statements in said source codes before accesses of said shared resources; and
d) inserting ending protection statements in said source codes after accesses of said shared resources.

2) The method of claim 1) where initial protection statements set a mutex or semaphore and ending protecting statements reset a mutex or semaphore.

3) The method of claim 1) where initial protection statements turn off interrupts and ending protecting statements turn on interrupts.

4) The method of claim 1) where initial protection statements and ending protecting statements are independent of specific operating system software.

5) A method for creating a list of shared resources of a computer that are accessed by a plurality of computer programs running on said computer, comprising:
a) clearing a task flag;
b) reading source codes of said computer programs;
c) recognizing a task declaration statement in said source codes and setting said task flag;
d) recognizing an end-of-task statement in said source codes and clearing said task flag;
e) recognizing said shared resource declaration statements in said source codes when said task flag is not set; and
f) adding identifiers for said shared resources to a list.

6) A method for determining statements that access shared resources of a computer within source codes of a plurality of tasks of computer programs running on said computer, comprising:
a) clearing a task flag;
b) reading said source codes;
c) recognizing a task declaration statement in said source codes and setting said task flag;
d) recognizing an end-of-task statement in said source codes and clearing said task flag; and
e) recognizing statements in said source codes that access said shared resources when said task flag is set.

7) The method of claim 6) further comprising:
a) recording the locations of statements in said source codes that access said shared resources within tasks.

8) The method of claim 6) further comprising:
a) incrementing a counter corresponding to a said shared resource for each task that accesses said shared resource at least once.

9) The method of claim 8) further comprising:
a) eliminating from said list of said shared resources entries for all said shared resources that have a corresponding counter with a value of 0 or 1 after said source codes have been entirely read.

10) A method for protecting statements within the source codes of a plurality of computer programs running on a computer that access shared resources on said computer, comprising:
a) creating a list of said shared resources;
b) creating a list of statements in tasks within said source codes that access said shared resources;
c) clearing a task flag;
d) reading said source codes;
e) recognizing a task declaration statement in said source codes and setting said task flag;
f) recognizing an end-of-task statement in said source codes and clearing said task flag;
g) determining whether a statement is in said list of statements;
h) inserting an initial protection statement in said source codes before a statement that is in said list of statements; and
i) inserting an ending protection statement in said source codes after a statement that is in said list of statements.

11) The method of claim 10) where initial protection statements set a mutex or semaphore and ending protecting statements reset a mutex or semaphore.

12) The method of claim 10) where initial protection statements turn of interrupts and ending protecting statements turn on interrupts.

13) The method of claim 10) where initial protection statements and ending protecting statements are independent of specific operating system software.

14) An apparatus including a software program for protecting shared resources of a computer that are accessed by a plurality of computer programs running on said computer, comprising:
a) means for reading source codes of said computer programs and identifying said shared resources;
b) means for reading said source codes and identifying accesses to said shared resources;
c) means for inserting initial protection statements in said source codes before accesses of said shared resources; and
d) means for inserting ending protection statements in said source codes after accesses of said shared resources.

15) The apparatus of claim 14) where initial protection statements set a mutex or semaphore and ending protecting statements reset a mutex or semaphore.

16) The apparatus of claim 14) where initial protection statements turn off interrupts and ending protecting statements turn on interrupts.

17) The apparatus of claim 14) where initial protection statements and ending protecting statements are independent of specific operating system software.

18) An apparatus for creating a list of shared resources of a computer that are accessed by a plurality of computer programs running on said computer, comprising:
a) means for clearing a task flag;
b) means for reading source codes of said computer programs;
c) means for recognizing a task declaration statement in said source codes and setting said task flag;
d) means for recognizing an end-of-task statement in said source codes and clearing said task flag;
e) means for recognizing said shared resource declaration statements in said source codes when said task flag is not set; and
f) means for adding identifiers for said shared resources to a list.

19) An apparatus determining statements that access shared resources of a computer within source codes of a plurality of tasks of computer programs running on said computer, comprising
a) means for clearing a task flag;
b) means for reading said source codes;
c) means for recognizing a task declaration statement in said source codes and setting said task flag;
d) means for recognizing an end-of-task statement in said source codes and clearing said task flag; and
e) means for recognizing statements in said source codes that access said shared resources when said task flag is set.

20) The apparatus of claim 19) further comprising:
a) means for recording the locations of statements in said source codes that access said shared resources within tasks.

21) The apparatus of claim 19) further comprising:
a) means for incrementing a counter corresponding to a said shared resource for each task that accesses said shared resource at least once.

22) The apparatus of claim 21) further comprising:
a) means for eliminating from said list of said shared resources entries for all said shared resources that has a corresponding counter with a value of 0 or 1 after said source codes have been entirely read.

23) An apparatus for protecting statements within the source codes of a plurality of computer programs running on a computer that access shared resources on said computer, comprising:
a) means for creating a list of said shared resources;
b) means for creating a list of statements in tasks within said source codes that access said shared resources;
c) means for clearing a task flag;
d) means for reading said source codes;
e) means for recognizing a task declaration statement in said source codes and setting said task flag;
f) means for recognizing an end-of-task statement in said source codes and clearing said task flag;
g) means for determining whether a statement is in said list of statements;
h) means for inserting an initial protection statement in said source codes before a statement that is in said list of statements; and
i) means for inserting an ending protection statement in said source codes after a statement that is in said list of statements.

24) The apparatus of claim 23) where initial protection statements set a mutex or semaphore and ending protecting statements reset a mutex or semaphore.

25) The apparatus of claim 23) where initial protection statements turn of interrupts and ending protecting statements turn on interrupts.

26) The apparatus of claim 23) where initial protection statements and ending protecting statements are independent of specific operating system software.
